(19) United States
(12) Patent Application Publication
(10) Pub. No.: US 2002/0128396 A1
(43) Pub. Date: Sep. 12, 2002

(54) Process for the preparation of superabsorbers from polyacrylonitrile emulsions under adiabatic reaction conditions

(76) Inventors: Gunter Sackmann, Leverkusen (DE); Rolf-Volker Meyer, Much (DE); Sergej Schapowalow, Saratov (RU); Telman Bayburdov, Saratov (RU); Lyudmila Stupen'Kova, Saratov (RU); Igor Nakonetschny, Saratov (RU)

Correspondence Address: BAYER CORPORATION, PATENT DEPARTMENT, 100 BAYER ROAD, PITTSBURGH, PA, 15205, US

(21) Appl. No.: 09/995,330

(22) Filed: Nov. 27, 2001

(30) Foreign Application Priority Data
Nov. 30, 2000 (DE) 100 59 593.6

(51) Int. Cl. C08F 120/44

(52) U.S. Cl. 525/329.1; 525/369

(57) ABSTRACT

The invention relates to a process for the preparation of superabsorbent polymers based on fine-particled non-crosslinked and/or crosslinked aqueous polyacrylonitrile emulsions.

### FIELD OF THE INVENTION

The invention relates to a process for the preparation of superabsorbent polymers based on fine-particled non-crosslinked and/or crosslinked aqueous polyacrylonitrile emulsions.

### BACKGROUND OF THE INVENTION

Superabsorbent polymers are known and are chiefly employed in the production of diapers and incontinence articles, and also as water-storing materials in agriculture and for sheathing electric cables. The commercially available superabsorbent polymers are as a rule water-insoluble polymers with wide-mesh crosslinking based on alkali metal salts of polyacrylic acids or of copolymers of acrylic acid and acrylonitrile obtained by copolymerization, initiated by free radicals, of acrylic acid and polyfunctional monomers, such as e.g. divinylbenzene, ethylene glycol di-methacrylate, ethylene glycol diallyl ether, butanediol acrylate, hexanediol meth-acrylate, polyglycol diacrylate, trimethylolpropane diacrylate, allyl acrylate, diallyl-acrylamide, triallylamine, diallyl ether, methylenebisacrylamide and N-methylol-acrylamide. Because of their molecular structure, such polymers are capable of taking up large amounts of liquids, by swelling and forming hydrogels, and of holding these even under pressure.

The patent applications EP-A-670 335 and EP-A-697 416 describe superabsorbent polymers with an extremely high swelling capacity and high gel strengths. These products are obtained by alkaline hydrolysis of polyacrylonitrile (PAN) emulsions at temperatures of between 50-100° C. and reaction times of 1 to 2 hours. In this process, after the hydrolysis, products with superabsorbent properties are isolated as finely divided powders by precipitating out with solvents, such as e.g. aliphatic monoalcohols. After filtration and drying, the superabsorbent polymers are ground to the desired particle size spectrum.

The finely divided, aqueous, high molecular weight, non-crosslinked or crosslinked polyacrylonitrile emulsions required for the preparation of the superabsorbent polymers are obtained by homo- and/or copolymerization of acrylonitrile in the presence of specific anionic polymeric emulsifiers (EP-A-590 460). The molecular weights of the non-crosslinked polyacrylonitrile emulsions prepared by this process are in the range from 5×10⁵ to 1×10⁷ g/mol, preferably 2×10⁶ to 5×10⁶ g/mol. The particle sizes of the non-crosslinked or crosslinked aqueous PAN emulsions are in the range between 100 and 300 nm, preferably between 100 and 200 nm (determined by means of laser correlation spectroscopy).

In the hydrolysis of such PAN emulsions with aqueous solutions of alkali metal hydroxides, the partly hydrolysed homo- and/or copolymers of acrylonitrile are formed, 30 to 80 mol % of the nitrile groups being converted into carboxylate groups and 20 to 70 mol % of the nitrile groups being converted into carboxamide groups and 0 to 20 mol % of the nitrile groups remaining unchanged.

Because of the transition of the low-viscosity PAN emulsions into the high-viscosity, water-swollen state which occurs as hydrolysis starts, a concentration limit is very rapidly reached when the discontinuous process described is carried out in conventional stirred apparatus. Only reaction mixtures with polyacrylonitrile concentrations up to a maximum of 13-15 wt. % can be employed.

Specialised apparatus is required for discontinuous and for continuous processing of those gelatinous reaction mixtures which as occur when PAN emulsions with solids concentrations of greater than 15 wt. % are employed. EP-A-783 005 describes a process for the continuous preparation of superabsorbent polymers in which aqueous emulsions of crosslinked or non-crosslinked polyacrylonitrile homo- and/or copolymers are hydrolysed by reaction with aqueous alkali metal hydroxide solutions at 70 to 100° C. in a mixing and kneading long-term reactor operating continuously for carrying out high-viscosity reactions (“List reactor”).

The construction of the “List reactor” allows hydrolysis reactions to be carried out on PAN emulsions in highly concentrated reaction mixtures. The concentrations of the crosslinked and/or non-crosslinked polyacrylonitrile emulsions in the reaction mixture during the hydrolysis may be 10 to 40 wt. % here, so that as a consequence of the hydrolysis induced weight increase of the polymer of approx. 60%, based on the polyacrylonitrile to be hydrolysed, the final concentration in the reaction mixture is between 16 and 60 wt. %.

A disadvantage of this process is the significantly higher technical outlay compared with conventional reactors, because of the significantly more complicated construction of the apparatus.

### DETAILED DESCRIPTION OF THE INVENTION

A process has now been found which allows the preparation of superabsorbent polymers reproducibly and in a simple apparatus by alkaline hydrolysis of polyacrylonitrile emulsions in highly concentrated reaction mixtures.

The invention provides a process for the preparation of superabsorbent polymers in which non-crosslinked and/or crosslinked highly concentrated aqueous polyacrylonitrile emulsions are hydrolysed under adiabatic reaction conditions (“in block form”) by mixing with an alkali metal hydroxide solution and without subsequent further mixing. The starting concentration of (co)polyacrylnitrile in the highly concentrated aqueous reaction mixture is 10 to 40 wt. % and the starting temperature of the reaction mixture is 10 to 40° C., preferably 20 to 30° C. Because of the released heat of reaction, the temperature of the reaction mixture rises to 70 to 80° C. in the course of 1.5 to 2.5 hours. The rate of this rise in temperature may be controlled by (i) a change in the starting temperature by the thickness of the layer of the reaction mixture or by (ii) a change in the concentration and the stoichiometric ratios of the components in the starting reaction mixture.

As the temperature of the reaction mixture rises, the colour thereof changes from bright red to dark red, and when the maximum temperature (70-80° C.) is reached, immediate decolorization of the reaction mixture starts, and a product which is no longer free-flowing and assumes the form of a highly viscous elastic gel is formed. The residence time after the maximum temperature is reached is in the range from 0 to 6 hours, preferably 1 to 5 hours. The total duration of the hydrolysis is between 2 and 8 hours, preferably between 3 and 6 hours. The molar ratio here of nitrile groups in the starting polymers to the hydroxyl groups of the alkali metal hydroxides is in the range from 1:0.5 to 1:1, preferably 1:0.6 to 1:0.8.

Under these adiabatic conditions the final volume of the reaction mixture (gel) may increase by 10 to 30 vol. % because of the ammonia which is released in the course of the hydrolysis.

By the process according to the invention it is possible to prepare reaction mixtures with a solids concentration of more than 35 wt. %.

An apparatus such as is already employed in adiabatic “block” solution polymerization of acrylamide and/or acrylic acid (U.S. Pat. No. 4,482,682, DE-A 1 218 167) is suitable, for example, for carrying out the aqueous alkaline hydrolysis of high molecular weight polyacrylonitrile emulsions in highly concentrated reaction mixtures under the pseudoadiabatic conditions described.

Further working up of the elastic gel formed after the alkaline hydrolysis to give the desired powdery product with superabsorbent properties may be carried out using generally known process technology methods (e.g. analogously to EP-A 783 005 and EP-A 670 335), in particular comminution of the gel, neutralization, washing, drying and grinding. The comminution of the elastic gel to gel particles with a particle size of 1 to 5 mm may be carried out in an extruder equipped with a perforated plate. Neutralization of the product may be carried out either in a water-alcohol mixture or by spraying acid on to the surface of the gel granules. After this spraying operation, the product is washed with a water-alcohol mixture and isolated by filtration. After this residue on the filter has been dried, ground and classified to the desired particle size range of 100 to 850 μm, the superabsorber ready for use is obtained. The drying, grinding and classifying is done according to the state of art described in “Modern Superabsorbent Polymer Technology” editor: F. I. Buchholz, A. T. Granham, Wiley-VCH, New York, 1998 ISBN 0 471 19411-5, chapter 3.2.4.2, page 85-87, 3.2.5 and 3.2.6.

The superabsorbent polymers obtainable in the manner described above have excellent properties. Products which have been produced from non-crosslinked PAN emulsions thus achieve degrees of swelling of between 380 and 700 g/g in deionized water and between 45 and 60 g/g in a 0.9% NaCl solution.

If the superabsorbent polymers which have been obtained on the basis of non-crosslinked polyacrylonitrile emulsions are subjected to a heat treatment at temperatures of between 150 and 250° C., preferably between 170 and 200° C., their properties are further significantly improved. This particularly applies to the rate of absorption of the superabsorbers for liquids and the gel strengths of the swollen polymers. Furthermore, their uptake capacity for aqueous liquids under pressure is increased and the water-soluble content in the products is reduced by this treatment. The duration of the heat treatment of the products at the temperatures mentioned is between 2 and 30 minutes, preferably between 5 and 20 minutes.

Superabsorbers based on PAN emulsions that are crosslinked to a low degree with divinylbenzene the degrees of swelling of the superabsorbers obtained after hydrolysis of these emulsions here are in the following ranges: between 300 and 450 g/g in deionized water and between 30 and 47 g/g in 0.9% NaCl solution. If the superabsorbers prepared in the manner described above are also additionally subjected to a subsequent surface modification, the products then also show, in addition to their high swelling capacity, anti-gel blocking properties, which manifests itself in their high absorbency under load (AUL) values at 0.3 psi and at 0.7 psi. Such a modification (analogously to EP-A 936 223) may be carried out on the surface of the ground and graded particles in a water/alcohol mixture with formaldehyde or other aldehydes, such as e.g. glutaraldehyde, as the crosslinking agent and in the presence of colloidal silica. A simultaneous surface crosslinking and an immobilization of the silica employed takes place by this treatment, as a result of which the improvement mentioned for the use properties occurs.

The superabsorbent polymers according to the invention may be employed, for example, in hygiene products, such as babies' diapers and incontinence articles, as water-storing materials in agriculture or in the sheathing of electric cables. The application provides hygiene articles, water-storing materials in agriculture and sheathings of electric cable produced from the superabsorbent polymers according to the invention.

### EXAMPLES

### Example 1

A non-crosslinked polyacrylonitrile emulsion with a solids content of 28.9 wt. %, a [η] value of 8.6 dl/g and an average particle size of 120 nm was employed for the hydrolysis.

A homogenized reaction mixture of 20.0 kg of this PAN emulsion and 7.332 kg of a 47 wt. % aqueous NaOH solution is initially introduced at 25° C. under nitrogen into a 60 1 reactor without a stirrer, at the base of which is an opening.

The layer thickness of the reaction mixture in the reactor is approx. 20 cm.

At the start of the hydrolysis the starting reaction mixture accordingly has the following composition:

| Concentration of polyacrylonitrile ([PAN]) | 21.14 wt. % |
|---|---|
| Concentration of sodium hydroxide solution ([NaOH]) | 12.61 wt. % |
| Molar ratio of PAN to NaOH | 1:0.79 |
| Weight ratio of PAN to water | 1:3.13 |

The reaction mixture heats up adiabatically to a temperature of 79° C. in the course of 2 hours due to the heat of reaction released. Thereafter, the reaction mixture is kept at this temperature in the reactor for a further 4 hours. The total residence time is 6 hours. After this reaction time a carboxyl group content of 75 mol % was reached (determined by means of IR spectroscopy). A highly elastic gel block is formed after the reaction.

When the hydrolysis has ended, the ammonia liberated, which is approx. 15 wt. % of the total amount of ammonia liberated, is removed from the reactor under an N₂ stream via specific discharge openings and is then absorbed by passing into 20% sulfuric acid. (The remaining 85 wt. % of the amount of ammonia released remains in the gel block and a large proportion is removed during comminution of the gel in the extruder under an N₂ stream. The remaining 20 to 23 wt. % is neutralized in a water-alcohol mixture with acetic acid.)

Further working up of the gel to give the powdery product was carried out using known process technology methods (comminution of the gel, neutralization, drying, grinding).

The elastic gel formed, in the form of a block, is taken out through the opening in the bottom of the reactor (to a certain extent the block falls out of the reactor by itself).

The gel is then cut into smaller pieces and comminuted to a particle size in the range from 1 to 5 mm under an N₂ stream in an extruder equipped with a perforated plate, with simultaneous removal of the ammonia.

The comminuted, non-tacky gel granules obtained are divided into three portions of equal size for carrying out the neutralization. The first portion is neutralized in a water-ethanol mixture with 20% acetic acid. The volume ratio of ethanol to water in the mixture here is 1:1 to 1:1.2. After the product has been filtered off and washed, it is dried at temperatures of between 70 and 80° C. Thereafter, the dried product is ground down to a particle size range of 100 to 850 μm.

Test Methods

Determination of the Degree of Swelling

250 mg of the superabsorbent polymer to be investigated is weighed into a 300 ml glass beaker, 250 to 300 ml distilled water or 50 ml of a 0.9 wt. % NaCl solution are poured over and the mixture is left to stand.

After the equilibrium swelling state has been reached, the gel obtained is filtered off over a filter cloth with a mesh width of 30 μm or filter paper and weighed. The degree of swelling is then calculated from the ratio of end weight to starting weight in g/g. Each determination is carried out three times. The measurement accuracy is approx. 5%.

For the product prepared according to example 1, a degree of swelling of 630 g/g in distilled water and of 57.5 g/g in 0.9% NaCl solution results.

pH Determination

The pH in 0.9% NaCl solution of the product obtained according to example 1 is 6.5.

Determination of the Water-soluble Content (WSC)

0.5 g of the superabsorbent polymer is mixed with 500 ml deionized water and the mixture is stirred at 20° C. for 16 hours. After the gel has been filtered off, the WSC is obtained from the gravimetric determination of the solids content in the filtrate and the wash water. In the case of the product obtained according to example 1, this is 16.5 wt. %.

### Examples 2 to 6

The hydrolysis conditions of the samples prepared according to examples 2 to 6 are summarized in table 1. For these examples, the hydrolysis of the PAN emulsions was carried out by a method corresponding to that described in example 1. In these cases the neutralization processes for the product were changed and the hydrolysis conditions (the PAN concentration in the reaction mixture, the PAN emulsion type, the molar ratio of PAN to NaOH, the weight ratio of PAN to water, the residence time and the starting temperature for the hydrolysis) were varied.

### Example 2

The product obtained according to example 1 in the form of gelatinous particles with a size of between 1 and 4 mm after comminution (second portion) was neutralized on the surface by spraying with 20% acetic acid. The product was then washed in an ethanol-water mixture with a volume ratio of ethanol to water of 1:1 and filtered. After drying, the product was ground to a particle size range of 100 to 850 μm.

### Example 3

The comminuted gel granules obtained according to example 1 (third portion) were dried at a temperature of 80° C. to a residual moisture content of approx. 15 wt. % without neutralization. A large proportion of the ammonia released is removed by this procedure and only approx. 3 to 4 wt. % still remains in the dried product, and is neutralized by acetic acid in the subsequent neutralization operation. The neutralization of the dried product with the particle size range of 0.3 to 2 mm was carried out in an ethanol-water mixture (volume ratio of ethanol to water 1:1) with 20% acetic acid.

After the neutralization, the product was filtered off, washed with ethanol-water and dried at a temperature of between 70 and 80° C. After drying, the product was ground such that a particle size distribution of 100 to 850 μm was obtained.

### Example 4

The finished product obtained according to example 2 with a particle size distribution of 100 to 850 μm was heated in a circulating air drying cabinet at a temperature of 180° C. for approx. 15 min.

### Example 5

A non-crosslinked PAN emulsion with a solids content of 30.8 wt. % and a [η] value of 9.0 dl/g with an average particle size of 120 nm was employed as the starting substance for the hydrolysis. The hydrolysis was carried out at a molar ratio of PAN to NaOH=1:0.7 by a process corresponding to that as described in example 1. The neutralization of the product was carried out under the same conditions as in example 1.

### Example 6

A crosslinked PAN emulsion obtained by copolymerization of acrylonitrile with 0.75 wt. % divinylbenzene, based on the acrylonitrile, and with a solids content of 28.2 wt. % and an average particle diameter of 115 nm was employed as the starting substance for the hydrolysis. The hydrolysis and the neutralization of this emulsion were carried out under the same conditions as described in example 1.

The degrees of swelling, in distilled water and in 0.9% NaCl solution, of the products prepared and the pH values and the amounts of water-soluble contents of the superabsorbent products, the particle size distribution of which is in each case between 100 and 850 μm, are shown in the last four columns of table 1.

The high degrees of swelling measured very clearly show the excellent properties of the superabsorbers obtained by hydrolysis carried out under adiabatic conditions.

### Comparison Example 7

(In Accordance with EP 783 005)

A polyacrylonitrile emulsion crosslinked to a low degree by incorporation of 0.75 wt. % divinylbenzene and with an average particle size of 118 mm and a solids content of 24.2% was employed for the hydrolysis.

This hydrolysis carried out in a high-viscosity reactor (“List reactor”) is defined by the following parameters:

PAN emulsion=crosslinked; [cPAN] in wt. %=19.9; molar ratio of PAN: NaOH=1:0.525; temperature [°C.]=95; degree of filling of the reactor [vol. %]=72.1; residence time [h]=2.0; solids content after the hydrolysis [wt. %]=32.7; degree of swelling [g/l] in water=525; in 0.9% NaCl solution=55.

The reaction conditions and the use properties of the product thereby obtained are shown in Table 1.

TABLE 1

| | | Hydrolysis conditions | | | | | | | | | | | |
|---|---|---|---|---|---|---|---|---|---|---|---|---|---|
| | | Composition of the starting | | | | | | | | Properties | | | |
| | | reaction mixture | | | | | | | Carboxylate | Degree of | | | |
| Exam- | | | | MR* of | WR** of | Starting | End | | group | swelling | | pH in | |
| ple | | [PAN] | [NaOH] | PAN | PAN | tempera- | tempera- | RST*** | content | in | in 0.9% | 0.9% | WSC |
| no. | PAN emulsion | wt. % | wt. % | NaOH | water | ture To; ° C. | ture T; ° C. | [h] | mol % | water | NaCl | NaCl | wt. % |
| 1. | non-crosslinked | 21.14 | 12.61 | 1:0.79 | 1:3.13 | 25 | 79 | 6 | 75 | 630 | 57.5 | 6.5 | 16.5 |
| 2. | non-crosslinked | 21.14 | 12.61 | 1:0.79 | 1:3.13 | 25 | 79 | 6 | 75 | 665 | 59.0 | 6.3 | 17.0 |
| 3. | non-crosslinked | 21.14 | 12.61 | 1:0.79 | 1:3.13 | 25 | 79 | 6 | 75 | 380 | 50.1 | 6.5 | 14.3 |
| 4. | non-crosslinked | 21.14 | 12.61 | 1:0.79 | 1:3.13 | 25 | 79 | 6 | 75 | 360 | 47.9 | 6.45 | 12.0 |
| 5. | non-crosslinked | 22.88 | 12.09 | 1:0.70 | 1:2.84 | 30 | 80 | 3 | 64 | 390 | 50.4 | 6.4 | 14.0 |
| 6. | crosslinked | 20.77 | 12.38 | 1:0.79 | 1:3.21 | 30 | 80 | 6 | 73 | 360 | 48.0 | 6.35 | 10.5 |
| 7. | comparison | 19.9 | 7.89 | 1:0.525 | 1:3.63 | 95 | 95 | 2 | 49 | 525 | 55.0 | 6.0 | 12.5 |
| | crosslinked | | | | | | | | | | | | |

*MR - molar ratio
**WR - weight ratio
***RST - residence time;
WSC - water-soluble content

The superabsorbent polymers prepared according to examples 1 to 7 were additionally subjected to a surface modification with formaldehyde and silica. For the surface modification, in each case 35 g of the superabsorbent polymers obtained according to examples 1 to 7 were stirred for 20 minutes at room temperatures with 200 g of a reaction mixture of the following composition:

| | |
|---|---|
| 178.0 g | methanol |
| 18.0 g | deionized water |
| 3.0 g | silica |
| 1.0 g | formaldehyde |

After filtration over a suction filter, the crude product with a solids content of 70.1 wt. % was dried for 30 minutes at 98° C. in a circulating air cabinet.

The properties of these modified superabsorbers obtained according to examples 1 to 7 are summarized in table 2. The following properties were determined here:

Absorption by the modified cylinder method (DE-A 40 15 085);

In this method, the SAP sample was introduced into a Büchner funnel and swollen with 0.9% NaCl solution without applying external pressure (no ground glass cylinder). The final values obtained after 30 minutes are listed in table 2.

Absorption by the tea-bag method (European Disposables and Nonwovens Association (Edana) Brussels, Belgium—specification 440.0-96)

Retention (European Disposables and Nonwovens Association (Edana) Brussels, Belgium—specification 440.0-96)

AUL (Absorbency Under Load) at 0.3 psi and 0.7 psi (European Disposables and Nonwovens Association (Edana) Brussels, Belgium—specification 440.0-96)

The water-soluble contents (WSC) and the pH values of the superabsorbent polymers prepared according to examples 1 to 7 are additionally summarized in Table 2. All the investigations were carried out with 0.9% NaCl solution.

The excellent superabsorbent properties of the polymers prepared according to the invention, which manifest themselves in high values both for the retention and for the absorption under pressure (AUL), can also be seen here. The reduction in the contents of water-soluble portions has an extent of 10 to 15% by the subsequent surface modification of the superabsorbers, compared with the products from Table 1 which were not modified is noted.

TABLE 2

| Ex- | | | | | | | |
|---|---|---|---|---|---|---|---|
| am- | Absorption | | Reten- | | | | |
| ple | (Cylinder) | Tea-bag | tion | AUL [g/g] | | WSC | |
| no. | [g/g] | [g/g] | [g/g] | 0.3 psi | 0.7 psi | [wt. %] | pH |
| 1 | 40.8 | 42.9 | 29.0 | 27.9 | 22.1 | 13.9 | 6.5 |
| 2 | 43.0 | 45.8 | 31.1 | 26.0 | 20.1 | 14.2 | 6.3 |
| 3 | 41.1 | 43.8 | 29.4 | 29.2 | 22.5 | 13.0 | 6.5 |
| 4 | 43.0 | 44.3 | 29.8 | 31.0 | 24.2 | 10.3 | 6.45 |
| 5 | 43.3 | 45.0 | 30.5 | 29.8 | 22.7 | 12.0 | 6.4 |
| 6 | 43.5 | 44.6 | 30.0 | 29.0 | 23.0 | 9.5 | 6.35 |
| 7 | 43.1 | 44.5 | 30.3 | 28.9 | 22.7 | 10.3 | 5.98 |
| Com- | | | | | | | |
| par- | | | | | | | |
| ison | | | | | | | |

1. A process for the preparation of superabsorbent polymer comprising reacting a crosslinked and/or non-crosslinked (co)polyacrylonitrile under adiabatic conditions in the form of an aqueous emulsion with an alkali metal hydroxide solution in a reaction mixture with a starting concentration of (co)polyacrylnitrile of 10 to 40 wt. % and a starting temperature of 10° to 40° C. characterized in that no mechanical or thermal energy is additionally provided to the reaction mixture.

2. The process of claim 1 where temperature from 20 to 30° C. is applied.

3. The process of claim 1 wherein the (co)polyacrylonitrile and alkali metal hydroxide are present in relative amounts such that the molar ratio of the nitrile groups to the hydroxyl groups is in the range of 1:0.5 to 1:1.

4. The process according to claim 1 wherein reaction is carried out over a period of 3 to 6 hours.

5. The process of claim 1 wherein weight ratio of polyacrylonitrile to water is between 1:2 and 1:4.

6. The process of claim 1 wherein emulsion is of non-crosslinked (co)polyacrylonitrile further comprising subjecting the superabsorbent polymer to a heat treatment at 150° C. to 250° C.

7. The process of claim 1 further comprising modifying the surface of the superabsorbent polymer.

8. The superabsorbent polymer prepared according to claim 1.

9. A method of using the superabsorbent polymer of claim 1 comprising producing a member selected from the group consisting of hygiene article, water-storing material and sheathing for electric cables.

10. The hygiene article produced by the method of claim 9.

11. The water-storing material produced by the method of claim 9.

12. The sheathing of electric cables produced by the method of claim 9.
